(19) United States
(12) Patent Application Publication
(10) Pub. No.: US 2003/0097312 A1
(43) Pub. Date: May 22, 2003

(54) Network system, discriminative information managing method, server, and recording medium

(76) Inventors: Tatsuto Torikai, Kanagawa (JP); Atsushi Hanai, Kanagawa (JP); Sachiko Misumi, Tokyo (JP); Keisuke Kataoka, Kanagawa (JP); Eiji Shinohara, Kanagawa (JP); Shizuo Kamimura, Chiba (JP)

Correspondence Address: Alex Chartove, Morrison & Foerster LLP, Suite 300, 1650 Tysons Blvd., McLean, VA, 22102, US

(21) Appl. No.: 10/300,008

(22) Filed: Nov. 20, 2002

(30) Foreign Application Priority Data
Nov. 21, 2001 (JP) 2001-356665

(51) Int. Cl. G06F 17/60

(52) U.S. Cl. 705/26

(57) ABSTRACT

The system according to the present invention allows users to handle their own discriminative information such as “order No.” when using the online shopping service, because the system associates first discriminative information (user's order No.) with second discriminative information generated by the system. The second discriminative information is also associated with order data. Therefore, the system can specify the order data, even if the user notifies user's order No. to the system. According to this effect, the users are allowed to handle only their own discriminative information, thus, their tasks for managing purchase activities will be simplified.

### BACKGROUND OF THE INVENTION

1. Field of the Invention

The present invention relates to a network system for electronic commerce (EC), which improves usability, and to a method, a server, and recording medium for realizing the system.

2. Description of the Related Art

As growth of the Internet, “Online shopping” based on EC technology becomes very popular way of shopping. Typical steps to use such the online shopping are: user registration; accessing the online shopping web site; item selection; and accounting.

Generally, the online shopping site (merchandiser) assigns their own discriminative information (merchandiser's order No.) to each dealing.

Not only private customers but also business customers (companies, enterprises, organizations, and the like) often use the online shopping. Ordinary, such the business users also have their own discriminative information (user's order No.) for managing their dealings, however, the conventional online shopping services have not handled such the information. As a result, the business users have extra tasks through purchasing affairs, because they must handle both the merchandiser's order numbers and their own order numbers at their end when using the online shopping service.

The present invention has been made as a solution for the above inconvenience, and it is an object of the present invention to provide a network system which can handle user's own discriminative information.

### SUMMARY OF THE INVENTION

To achieve the above objects, a network system according to a first aspect of the present invention is a network system which provides a site for merchandising based on interactions with a terminal device connected to a network, comprises:

an information acceptor for accepting an order from the terminal device with first discriminative information designated by the terminal for discriminate the order;

an information generator for generating second discriminative information for discriminating the order;

an information storage for storing the first discriminative information accepted by the information acceptor and the first discriminative information generated by the information generator with associating the first discriminative information and second discriminative information with each other;

an order storage for storing order information representing details of the order and the second discriminative information generated by the information generator with associating the order information and second discriminative information with each other;

an information receiver for receiving the first discriminative information from the terminal device;

an information searcher for searching the information storage to find second discriminative information being associated with the first discriminative information received by the information receiver in response to the reception by the information receiver; and

an information presenter for presenting order information obtained from the order storage based on the second discriminative information found by the information searcher to the terminal device.

The network system may further comprise:

a discriminative information storage for storing discriminative information including user information for identifying users and organization information for identifying organizations to which the users belong, while associating the user information and the organization information with each other; and

an attribution discriminator for discriminating attribution of a user who accesses the site by determining whether organization information associated with user information of the user concerned is stored in the discriminative information storage or not, wherein

the information acceptor may accept the first discriminative information in a case where the user attribution discriminator determines that the organization information associated with the user is stored.

The first discriminative information may include item information which represents ordered items included in the order discriminated by the first discriminative information.

The order information may include at least item information representing ordered items, quantity information representing ordered quantities, price information representing prices of the ordered items, date information representing order date, destination information representing destination of the ordered items, and status information representing shipment status of the ordered items.

According to the above structures, users are allowed to handle their own discriminative information such as “order No.” when using the online shopping service, because the system associates first discriminative information (user's order No.) with second discriminative information generated by the system. Further, since the second discriminative information is also associated with order data, the system can specify the order data even if the user notifies user's order No. to the system. According to this effect, the users are allowed to handle only their own discriminative information, thus, their tasks for managing purchase activities will be simplified.

To achieve the above objects, a method according to a second aspect of the present invention is a method for providing online shopping service comprises:

accepting an order from a terminal device via a network with arbitrary first discriminative information designated by the terminal device for discriminating the order;

generating second discriminative information for discriminating the order;

storing the first discriminative information, the second discriminative information, and order information representing details of the order, while associating the first discriminative information, second discriminative information, and the order information with each other;

updating the order information in accordance with process for accepting the order; and

specifying second discriminative information being associated with first discriminative information given by the terminal device, and presenting updated order information being associated with the specified second discriminative information to the terminal device.

To achieve the above objects, a method according to a third aspect of the present invention is a method for managing discriminative information which is applicable to a network system for providing merchandising service with handling interactions with a terminal device connected to a network, comprises the steps of:

accepting an order from the terminal device with first discriminative information designated by the terminal device for discriminating the order;

generating second discriminative information for discriminating the order so as to be associated with the order;

storing the accepted first discriminative information and the generated second discriminative information while associating the first discriminative information and the second discriminative information with each other;

storing order information representing details of the order and the second discriminative information associated with the order while associating the order information and the second discriminative information with each other,

receiving the first discriminative information from the terminal device;

specifying associated second discriminative information based on the received first discriminative information; and

obtaining associated order information based on the specified second discriminative information, and presenting the order information to the terminal device.

To achieve the above objects, a server according to a fourth aspect of the present invention is a server connected to a network for providing a site for merchandising with dealing with a terminal device connected to the network, comprises:

a connecting unit which connects the server to the network;

an order accepting unit which controls the connector to accept an order from the terminal device together with first discriminative information arbitrary designated by the terminal device for discriminating the order;

an information generating unit which generates second discriminative information for discriminating the order accepted by the order accepting unit;

an information storing unit which stores the first discriminative information accepted by the order accepting unit and the second discriminative information generated by the information generating unit so that the first discriminative information is associated with the second discriminative information;

an order information storing unit which stores order information representing details of the order accepted by the order accepting unit and the second discriminative information generated by the information generating unit so that the order information is associated with the second discriminative information;

an information receiving unit which controls the connecting unit to receive first discriminative information from the terminal device;

an discriminative information retrieving unit which retrieves associated second discriminative information from the information storing unit in accordance with the first discriminative information received by the information receiving unit;

an order information retrieving unit which retrieves associating order information from the order information storing unit based on the second discriminative information retrieved by the discriminative information retrieving unit; and

a order information transmitting unit which controls the connecting unit to transmit the order information retrieved by the order information retrieving unit to the terminal device.

The server may further comprise an input page transmitting unit which controls to the connector to transmit an input page for inputting information representing the first discriminative information, to the terminal device.

The server may further comprise:

a discriminative information storing unit which stores discriminative information including user information for identifying users and organization information for identifying organizations to which the users belong so that the organization information is associated with the user information; and

an attribution discriminating unit which determines whether the user information of a user who accesses the server has associated organization information or not, to discriminate attribution of the user concerned, wherein

the information input page presenting unit may present the input page in a case where the attribution discriminating unit determines that the user information has the associated organization information.

Whole or a part of a program necessary for making a computer work as the above server may be stored in a recording medium (ROM, Flexible Disk, Hard Disk, CD-ROM, MO, CD-R, flash memory, or the like) for distribution.

### BRIEF DESCRIPTION OF THE DRAWINGS

These objects and other objects and advantages of the present invention will become more apparent upon reading of the following detailed description and the accompanying drawings in which:

FIG. 1 showing the structure of “Online Shopping System” according to embodiments of the present invention;

FIG. 2 showing the structure of a set of “In-Shop Terminal” and “In-Shop DB system” which is installed in each shop;

FIG. 3A exemplifying “Customer Data” in the in-shop DB system:

FIG. 3B exemplifying “Sales Data” in the in-shop DB system;

FIG. 3C exemplifying “Invoice Data” in the in-shop DB system;

FIG. 4 showing the structure of a set of “Master Server” and “Master DB system”;

FIG. 5A exemplifying “Item Data” in the master DB system;

FIG. 5B exemplifying “Customer Data” in the master DB system;

FIG. 5C exemplifying “Item Relation Data” in the master DB system;

FIG. 6 showing the structure of a set of “Shopping server” and “Shopping DB system”;

FIG. 7A exemplifying “Online User Data” in the shopping DB system;

FIG. 7B exemplifying “Order Data” in the shopping DB system;

FIG. 8 showing the structure of a set of “Shipping arrange server” and “Shipment DB system”;

FIG. 9A exemplifying “Shipping Priority Data” in the 'shipment DB system;

FIG. 9B exemplifying “Merchandise Availability Data” in the shipment DB system;

FIG. 9C exemplifying “Shipping Lead-time Data” in the shipment DB system;

FIG. 9D exemplifying “Inventory Data” in the shipment DB system;

FIG. 10 for explaining process before Item Selection;

FIG. 11 for explaining “Web Page Presentation Process” shown in FIG. 10;

FIG. 12 exemplifying “Top Page” presented by the web page presentation process shown in FIG. 11;

FIG. 13 exemplifying “Personalized Page” presented by the web page presentation process shown in FIG. 11;

FIG. 14 exemplifying “Category Select Page” linked to the personalized page shown in FIG. 13;

FIG. 15 for explaining “Item Notification Process” shown in FIG. 10

FIG. 16 for explaining “Inventory Check Process” shown in FIG. 10;

FIG. 17 for explaining “Shopping Page Presentation Process” shown in FIG. 10;

FIG. 18 exemplifying “Shopping Page” presented by the shopping page presentation process shown in FIG. 17;

FIG. 19 for explaining process after Item Selection;

FIG. 20 exemplifying “View Cart Page” presented by “Order Acceptance Process” shown in FIG. 19;

FIG. 21 exemplifying “Order Review Page” presented by “Order Reviewing Process” shown in FIG. 19;

FIG. 22 exemplifying “Dealing Report Page” presented by “Deal Completion Process” shown in FIG. 19;

FIG. 23 for explaining process for confirming “Order Status”;

FIG. 24 exemplifying “Order Designation Page” presented by the process shown in FIG. 23; and

FIG. 25 exemplifying “Shipment Report Page” presented by “Status Presentation Process” shown in FIG. 23.

### DETAILED DESCRIPTION OF THE PREFERRED EMBODIMENT

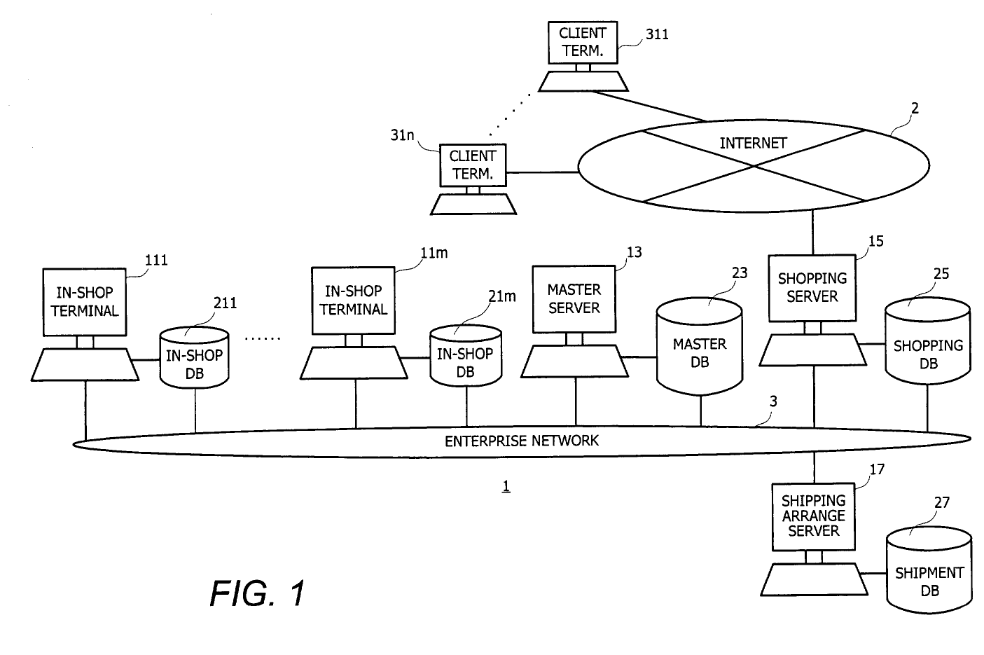

A preferred embodiment of the present invention will now be described with referring to accompanying drawings. FIG. 1 is a diagram schematically showing the structure of a network system according to the embodiment.

As shown in FIG. 1, the network system, comprises an enterprise network system 1, the Internet 2, and client terminals 31 (31₁-31ₙ). The enterprise network system 1 is a closed network system employed by a business body such as enterprise and organization. In this embodiment, such the business body is a merchandiser which provides online shopping service (hereinafter, referred to as “merchandiser”). The Internet 2 is an open network to which the client terminals 31 are connected.

The enterprise network system 1 comprises an enterprise network 3 which may be the Intranet system including LAN and WAN. The enterprise network 3 connects a plurality of in-shop terminals 11 (11₁-11ₘ) and in-shop DB systems 21 (21₁-21ₘ), a master server 13 and a master DB system 23, and a shopping server 15 and a shopping DB system 25, and a shipping arrange server 17 and a shipment DB system 27.

The in-shop terminals 11 are installed in authorized distributors, retailers, service centers and the like (hereinafter referred to as “shops”) affiliated with the merchandiser. The in-shop terminal 11 processes business tasks in the shop concerned. The in-shop DB system 21 collaborates with the corresponding in-shop terminal 11 to process the business tasks.

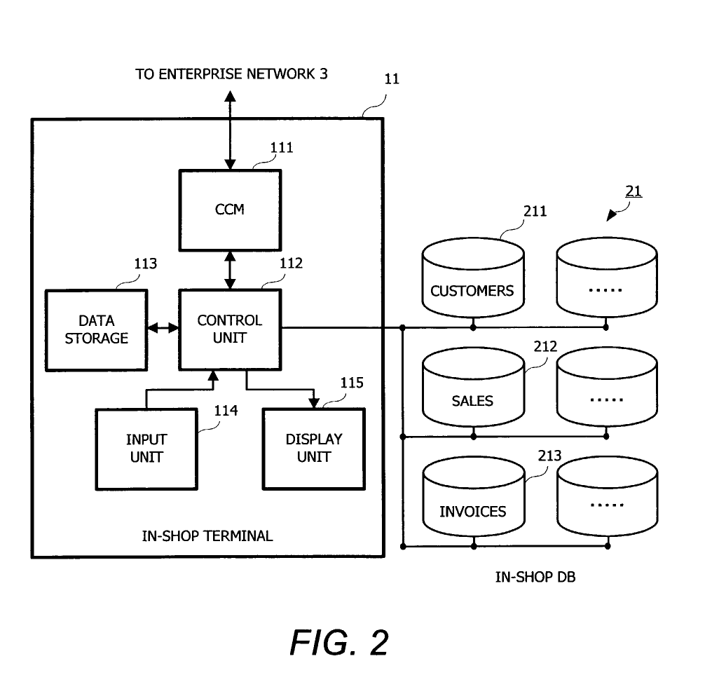

FIG. 2 shows the structures of the in-shop terminal 11 and the in-shop DB system 21. As shown in FIG. 2, the in-shop terminal 11 comprises a communication control unit (CCU) 111, a control unit 112, a data storage unit 113, an input unit 114, and a display unit 115.

The CCU 111 works as interface to the enterprise network 3 under control of the control unit 112 for data communications.

The control unit 112 controls the CCU 111 in accordance with commands or instructions from the input unit 114 to control the data communications, and executes any data processing tasks for the business. The control unit 112 also generates image data to be supplied to the display unit 115.

The data storage unit 113 may be semiconductor memory modules, disk drives, or the like, and stores data and programs.

The input unit 114 comprises a keyboard, pointing devices, and the like, to input commands, data, and the like.

The display unit 115 comprises a monitor, a VRAM, and the like which displays images in accordance with the image data from the control unit 112 to present (output) information.

The in-shop DB system 21 comprises databases 211-213 for storing customer data, sales data, and invoice data, respectively.

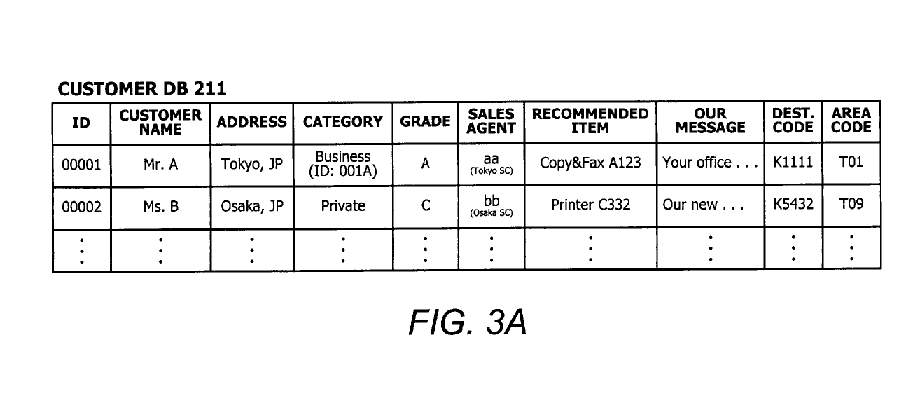

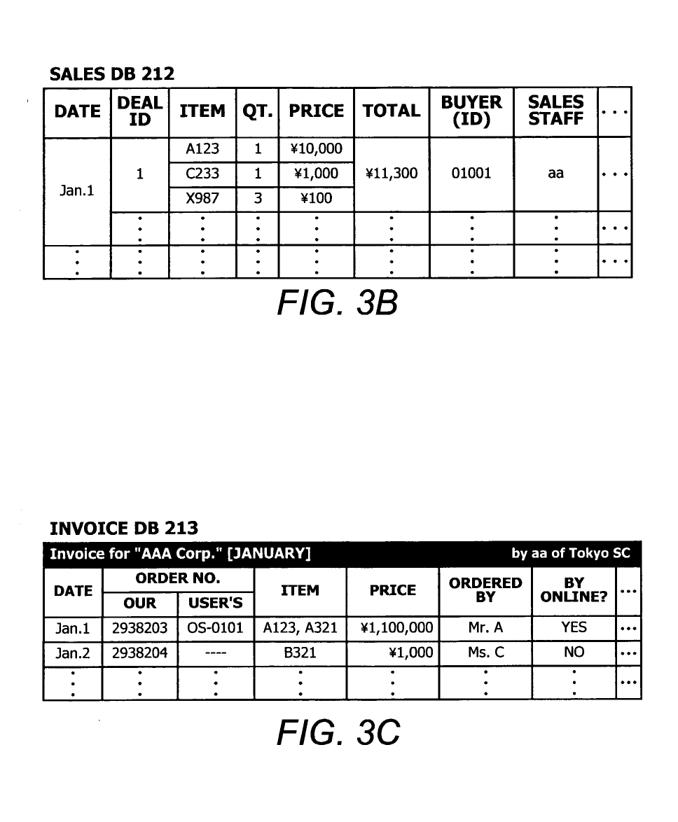

As shown in FIG. 3A, the DB 211 stores information regarding to the customers of the shop. The information may include Customer ID, User Name, Address, User Category (business customer (company ID affixed) or private customer), Customer Grade, Sales Agent, Recommended Items, Messages from the sales agent, destination code, area code, and the like.

“Customer ID” shows a unique ID assigned to each customer. “Customer Grade” shows rating of the customers which determined by the sales agent. The grade will be reflected to discount rate, discount coupons, or the like. “Recommended Items” shows items now recommended by the sales agent. “Message” may shows greeting messages from the sales agent. “Destination Code” and “Area Code” represents state, prefecture, city or the like, to specify destination for delivery. In addition to the table shown in FIG. 3A, the DB 211 also stores data regarding to the business customers (not shown). The data are categorized into records each for a company (enterprise), to which a unique company code (company ID) is assigned. Each of the records includes information regarding to persons who deal with purchasing affairs.

As shown in FIG. 3B, the DB 212 stores sales data. The data are categorized into records each for a unit of dealing. Each record includes information of: item code, quantity, and price of sold merchandises; buyer (customer ID); sales agent; and the like. Because the data are categorized by dealing unit, it is helpful for easy search for the sold items.

As shown in FIG. 3C, the DB 213 stores data of invoices (debit notes) issued monthly. The data are categorized into records each for a customer. Each of the records includes information of: Dealing Date; Order Number (including merchandiser's number and customer's number); Item Code, Quantity, and Price (sales price) of bought item; Ordered Person (in case of business customer); and the like. In this embodiment, the invoices for the enterprise customers are issued by the shops even if the enterprise customers uses online shopping. Therefore, the invoice data include flag information for distinguishing whether the dealing is done by online shopping or not (“Online User?” in FIG. 3C).

The master server 13 and the master DB system 23 shown in FIG. 1 collaborates with each other to handle whole the business tasks of the merchandiser.

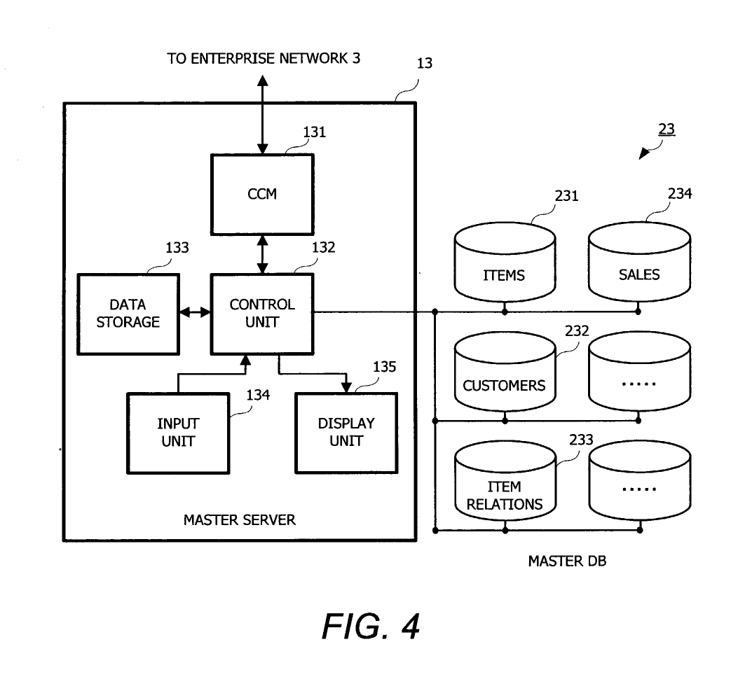

As shown in FIG. 4, the master server 13 comprises a communication control unit (CCU) 131, a control unit 132, a data storage unit 133, an input unit 134, and a display unit 135. Those components except the control unit 132 have the structures and functions which are the same as those of the corresponding components in the in-shop server 11. The control unit 132 is equipped with extra functions necessary for handling the tasks of whole business in the merchandiser.

The master DB system 23 handles collected data regarding to the whole business. As shown in FIG. 4, the master DB system 23 includes databases 231-234 each storing information of “Items”, “Customers”, “Item Relations”, and “Sales” respectively.

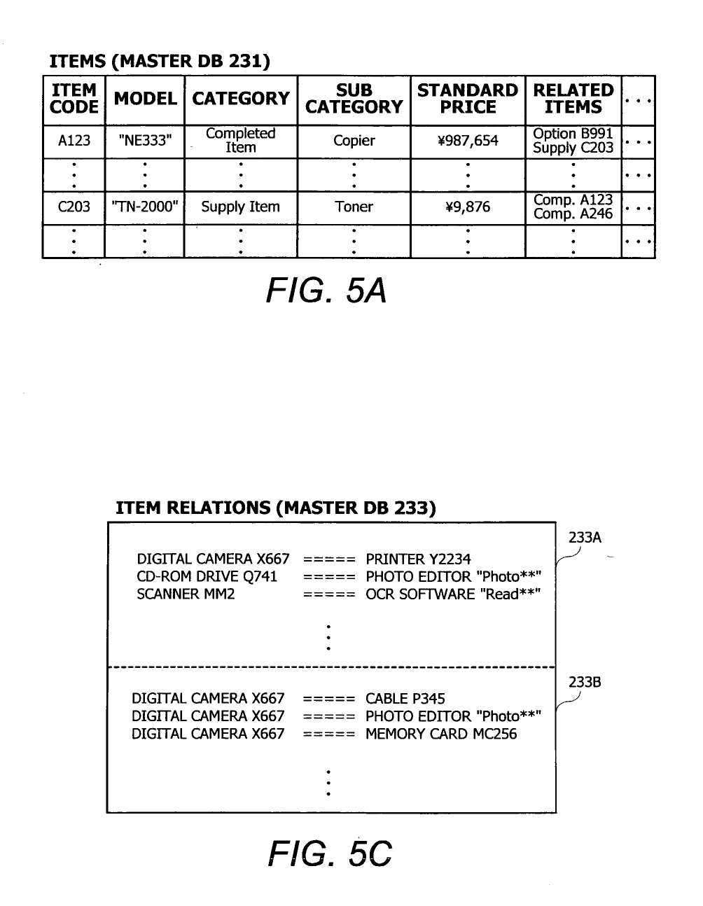

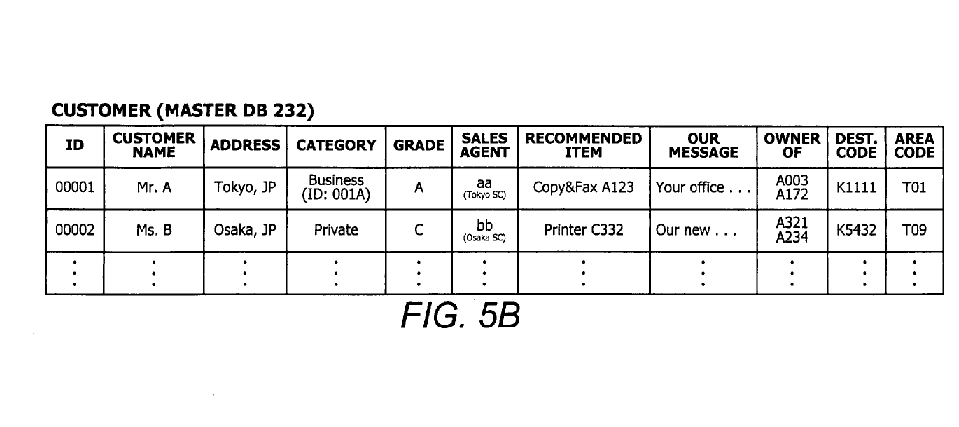

As shown in FIG. 5A, the DB 231 stores data of all items the merchandiser handles. The data include information of: “Item Code”, “Model”, “Category”, “Sub Category”, “Standard Price”, “Related Items”, and the like. “Category” represents categories of each listed item. That is, the items may be categorized to, for example, “Completed Item”, “Option Item”, and “Supply Item”. “Completed Item” represents items each of which has necessary functions as a whole to fulfil its purpose by itself. “Option Item” stands for items each of which is useless by itself, but collaborates with a certain completed item to provide it of extra functions. “Supply Item” means items to be used in the completed item or optional item, and which is exhausted through daily use. For example, in case of “Copier”, the copier itself belongs to “Completed Item”. An ADF (Automatic Document Feeder) unit, a sorter unit, a telecommunication unit, an extra power unit, and the like may belong to “Option Item”, because those items are installed in or attached to the copier for use. And, a toner cartridge, copy paper, and the like may belong to “Supply Item”. In case of “Digital Camera”, the digital camera itself is in “Completed Item” category. A cable which connects the digital camera to a PC, a software package for transferring images to the PC, and the like may be in “Option Item” category. And, a battery pack, a memory card, and the like may be in “Supply Item” category.

“Related Items” represents other items belonging to other categories but are compatible with the item concerned. In a case where the item concerned is categorized to “Completed Item”, item codes representing option items or supply items compatible with the completed item concerned are registered in “Related Items”. In the same manner, if the item concerned is an option item, item codes of the corresponding completed items or supply items are registered. If the item concerned is supply item, item codes of the corresponding completed items or option items are registered. That is, data in “Related Items” are prepared reciprocally. In FIG. 5A, “C203” is registered as a related item of “A123” and vice versa.

Since it has such the relational database structure, once a target item is specified, the related items are also specified immediately, thus it is helpful for searching items. That is, it is able to search an item based on related items and vice versa, or based on categories.

The DB 232 stores information regarding to all customers of the merchandiser. As shown in FIG. 5B, the contents of data are fundamentally the same as those in the DB 211 shown in FIG. 3A, however, it also includes information representing items (machines) which are already owned by each customer. As well as the DB 211, the DB 232 also stores data of the business customers (not shown).

As shown in FIG. 5C, the DB 232 stores information representing relations between a master item and other servant items being compatible with the master item. More precisely, the servant items are items which may be or should be bundled with the master item. In a case where a digital camera is purchased, for example, it is recommendable that a software package for retouching the captured photo images or a printer for printing the photo images is bundled with the digital camera. If the obviously recommendable relations are previously known, the operator of the master DB system 23 inputs information of such relations to an area 233A in the DB 233.

In addition to such the known relations, the market often reveals unpredicted relations in accordance with the customers' purchasing trend. In other words, if the trend shows that many customers tend to buy a certain item together with another certain item, and a relation between those items has not been registered, it means that a new relationship which has been unpredicted is found out. Such the relation should be registered as well as the registered known relations, because it reflects the actual customers' demand. Under such the situation, the control unit 132 checks the sales history to find out which item is often purchased together with another item. For example, the control unit 132 calculates the rate of bundling, and picks up items whose bundling rate exceeds a given threshold (for example, 5%). The control unit 132 registers information representing the relation between the picked up items in an area 233B in the DB 233.

The DB 234 stores data regarding to the whole sales of the merchandiser, that is, the data represents sales of all shops. The information stored in the DB 234 is fundamentally that stored in the DB 212 shown in FIG. 3B, that is, the information is distinguished by dealings. Therefore, the master server 13 can retrieve information representing bundled items from the data in the DB 234.

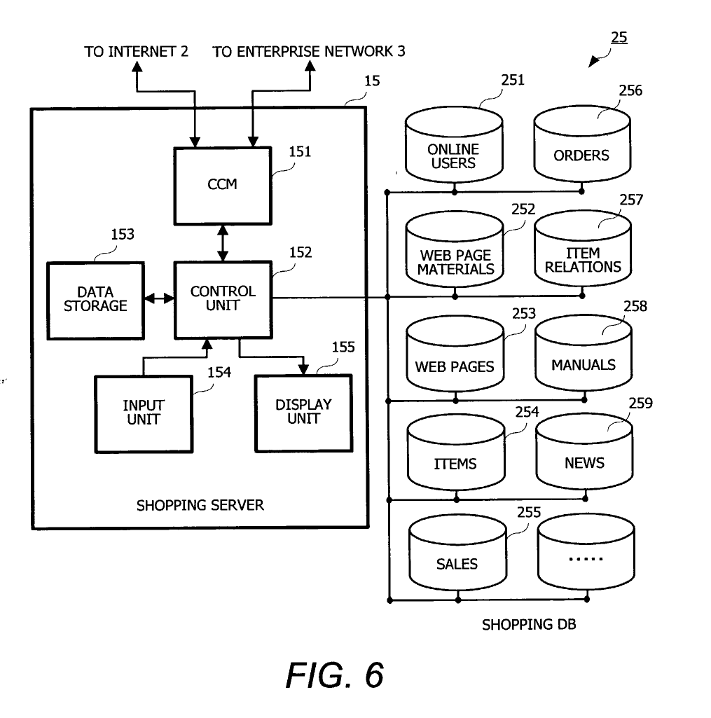

The shopping server 15 and the shopping DB system 25 collaborate with each other as a system to handle tasks for the online shopping. FIG. 6 shows the structures of them.

As shown in FIG. 6, the shopping server 15 comprises a communication control unit (CCM) 151, a control unit 152, a data storage unit 153, an input unit 154, and a display unit 155.

Those components except the control unit 152 have almost the same structures as those of the corresponding components in the in-shop terminal 11. The control unit 152 has extra functions for web page presentation and accounting tasks.

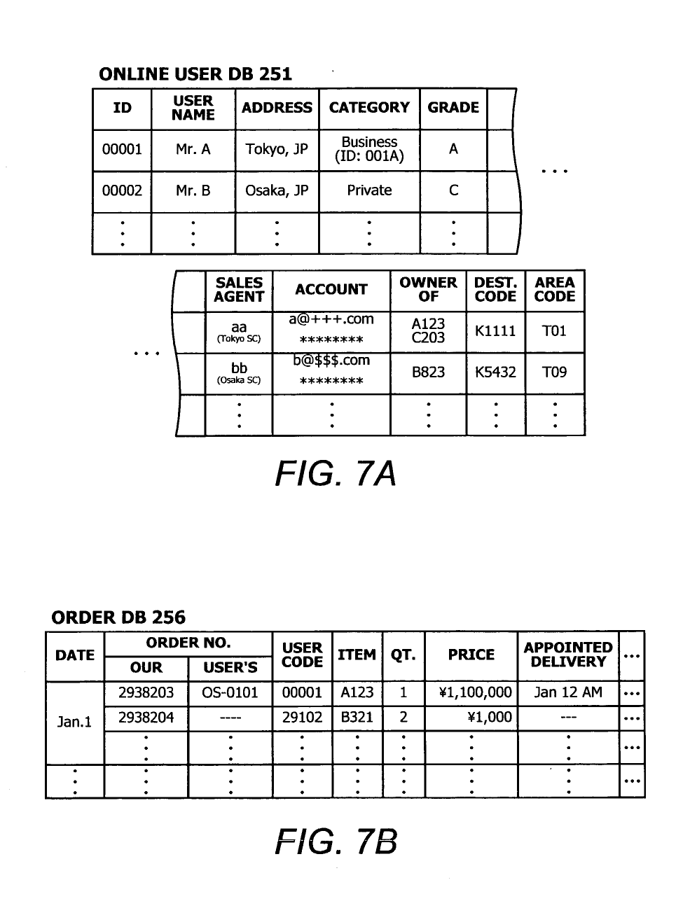

As shown in FIG. 7A, the shopping DB system 25 comprises databases 251-258 for storing online user data, web page materials, web page data, item data, sales data, order data, related items data, manual data, and news data, respectively.

The DB 251 stores data of online users including information of: Customer ID, User Name, Address, User Category (Business User (with company ID) or Private User), User Grade, Sales Agent who dealing with the user, Login Account (e-mail address and password), Owning Items, Destination Code, Area Code, and the like, as shown in FIG. 7A.

“Customer ID” may be duplicate of that registered in the in-shop terminal 11 or the master server 13. “Login Account” includes a pair of e-mail address and password those required at sign-in stage for the online shopping. In case of the business user, the login account belongs to persons in charge who dealing with purchasing (for example, persons belonging to General Affair Section, Purchase Section, or the like). “Owning Item” represents items (completed items) owned by the user. If a certain user has dealt only via the online shopping, its purchase history is registered. If a certain business user has dealt via the online shopping and the ordinary purchasing at the shop, the owning items reflect the purchase histories of the both ways. The number of Login Account is flexible in accordance with the number of the persons in charge.

The contents of Grade, Sales Agent, Destination Code, and Area Code may be duplicate of those registered in the DB 211 of the in-shop DB system 21. As well as the DB 211, the DB 251 also stores data of the business users (not shown).

The DB 252 stores data representing various materials for generating web pages. For example, it includes portrait images of the sales agents, pictures of the items, banner images, fixed texts, and the like.

The DB 253 stores data of web pages for the online shopping service.

The DB 254 stores data of the items handled by the online shopping. The data are duplicate of those stored in the DB 231 shown in FIG. 5A.

The DB 255 stores sales data categorized into the dealing unit as well as the DB 212 shown in FIG. 3B.

The DB 256 stores data regarding to orders handled by the online shopping. As shown in FIG. 7B, the data includes information of: date of dealing (Date), order No. (including merchandiser's order No. and user's order No.), user code, ordered item (Item), quantity (QT), price, delivery appointment (Appointed Date), and the like.

The DB 257 stores data of related items those dealt by the online shopping. The data are retrieved from the DB 233 of the master DB system 23.

The DB 258 stores electronic files representing user's manuals for the items.

The DB 259 stores data representing news retrieved from various news sources or provided by the shopping server 15. Those news materials are categorized into news categories.

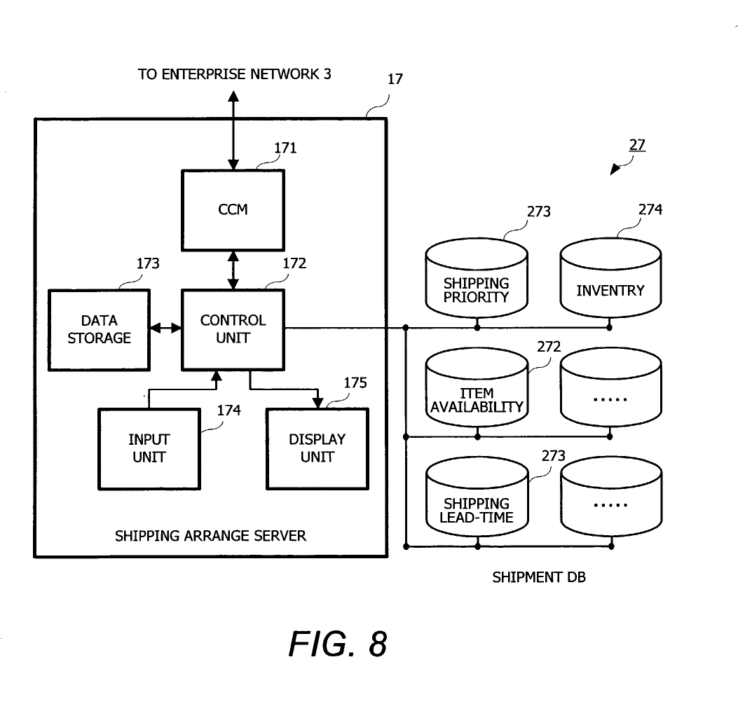

The shipping arrange server 17 and the shipment DB system 27 collaborate with each other to handle the orders, manage the inventory, and the like. FIG. 8 shows the structures of them.

As shown in FIG. 8, the shipping arrange server 17 comprises a communication control unit (CCU) 171, a control unit 172, a data storage unit 173, an input unit 174, and a display unit 175.

Those components except the control unit 172 have almost the same structures as those of the corresponding components in the in-shop terminal 11. The control unit 172 has the extra functions for arranging shipments, inventory management, scheduling shipments, or the like.

As shown in FIG. 8, the shipment DB system 27 has databases 271-274 each storing data of Shipping Priority, Merchandize Availability, Shipping Lead-time, and Inventory.

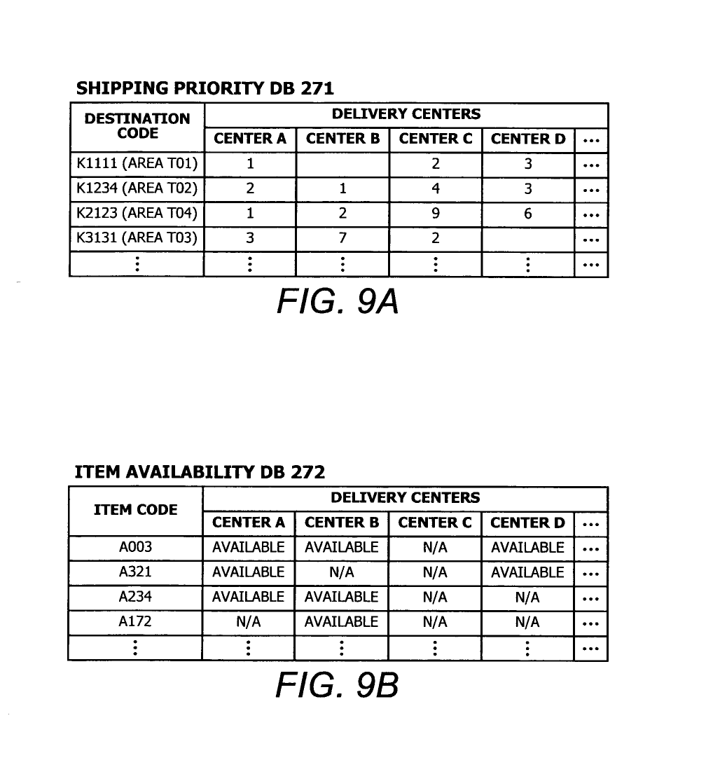

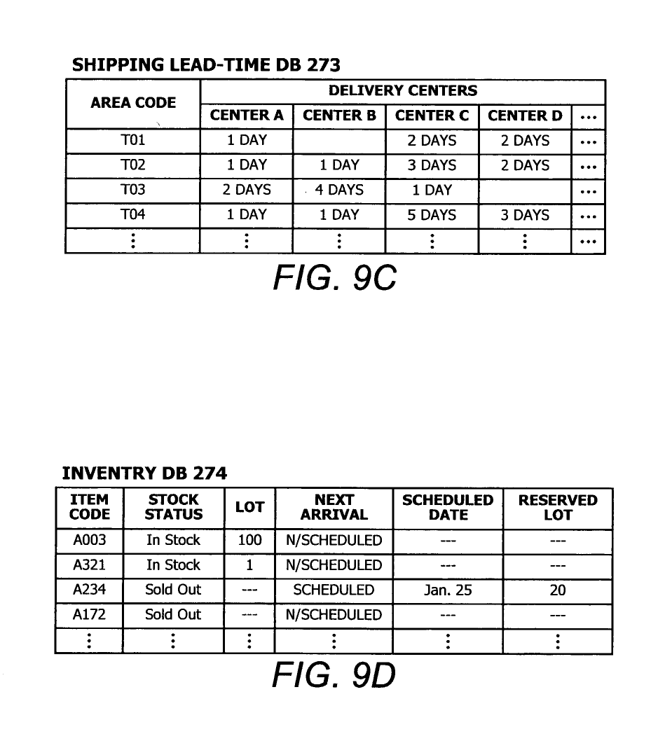

As shown in FIG. 9A, the DB 271 stores priority data applied to delivery centers affiliated with the merchandiser in accordance with the destination codes. The delivery arrange server 17 refers to those data to determine the appropriate delivery center based on the destination code.

As shown in FIG. 9B, the DB 272 stores data representing availability of the items at each delivery center. In FIG. 9B, the table has indicators of “Available” or “Not Available (N/A)” to show which item is available at which center.

As shown in FIG. 9C, the DB 273 stores data of shipment lead-time in accordance with the area codes. The “lead-time” shows that how many days are required for delivery (from the delivery center to the customer).

The DB 274 stores data of inventory to reveal stock status of the items. As shown in FIG. 9D, the data show stock status (“Stock Status”), stocked lot (“Lot”), schedule of next arrival (“Next Arrival”), date of next arrival (“Scheduled Date”), reserved lot at next arrival (“Reserved Lot”), and the like of each item (“Item Code”). The configuration of the stocked lot or reserved lot may depend on each delivery center.

[Operations through Activities]

Operations for the system having the above structure will now be described with reference to activities of the merchandiser.

[Operations at Shop]

The daily work of the sales agents in each shop is to contact to the customers for merchandising, and to find new customers.

Once a new order occurs, an operator of the in-shop terminal 11 operates the in-shop terminal 11 to register data regarding to the order to the DB 212 (sales data) of the in-shop DB system 21. A unique deal No. is applied to each order even if a plurality of items are ordered at once. In a case where a new customer is found, the sales agent registers data of that customer to the DB 211 (customer data).

The sales agents also input customer grade, recommended items, message to each customer, and the like.

The master server 13 constantly accesses the in-shop DB systems 23 and the shopping DB system 25, and retrieve updated data (difference) to update the master DB system 23. For example, data representing whole sales on that day is registered to the DB 234 (sales data). In relation to the sales update, the master server 13 also updates customer data in the DB 232 to reflect the items (completed items) owned by the customers. The master server 13 updates the customer data in the DB 232 when modifications or additions (new customer) occur.

The master server 13 also retrieves data of customer grade, recommended items, messages, and the like from the DB 211 (customer data) in each shop, and duplicates them to the DB 251 (online user data) of the shopping DB system 25. Further, the master server 13 generates data representing item relations based on the update of the DB 234 (sales data), and configures the DB 233 (item relation data). Furthermore, the master server 13 retrieves data regarding only to the items handled by the online shopping from the updated item relation data, and registers retrieved data to the DB 257 (item relation) via the shopping server 15.

[User Registration for Online Shopping]

A business user who intend to use the online shopping service provided by the system of this embodiment must make an application to the shop for membership. The application requires at least user account(s) (that is, e-mail address and password) of the person(s) in charge. The information written on the application is transferred to an operator of the shopping server 15 to register it to the DB 251 (online user data) as shown in FIG. 7A. The operator also contacts to the sales agents in the shops to set information of user grade and the like which are determined by the sales agents in order to coordinate with the services provided by each shop.

On the contrary, a private user who intends to use the online shopping service may operates the client terminal 31 to access a web page for user registration presented by the shopping server 15. The access may be established via an ISP (Internet Service Provider: not shown) and the Internet 2. The registration page requires the user to input e-mail address, address, name, payment method, and the like. After the registration is completed, the shopping server 15 issues password to the user, and registers it to the DB 251 (online user data) together with user ID.

[Operations for Online Shopping Service]

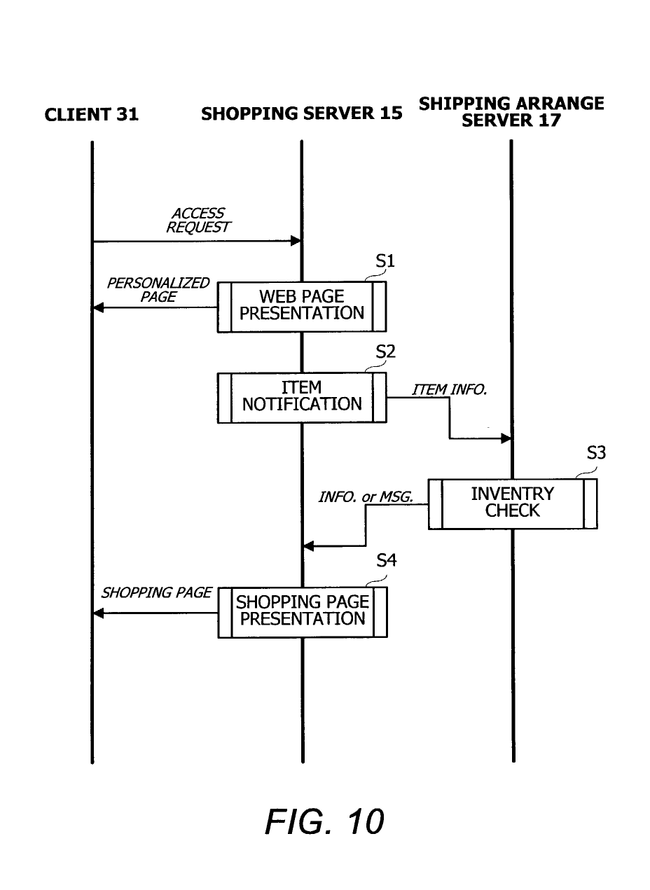

Operations for using the online shopping service will now be described. A home page of the web site for the online shopping presented by the shopping server 15 is an open web page which accepts any accesses from the client terminals 31 operated by arbitrary users. In response to the access from the client terminal 31, the shopping server 15 starts “Web Page Presentation” process shown in FIG. 10 (step S1). Through the web page presentation process, the shopping server 15 identifies users based on data from the client terminal 31, and decides whether the accessing user is allowed to access the personalized pages or not.

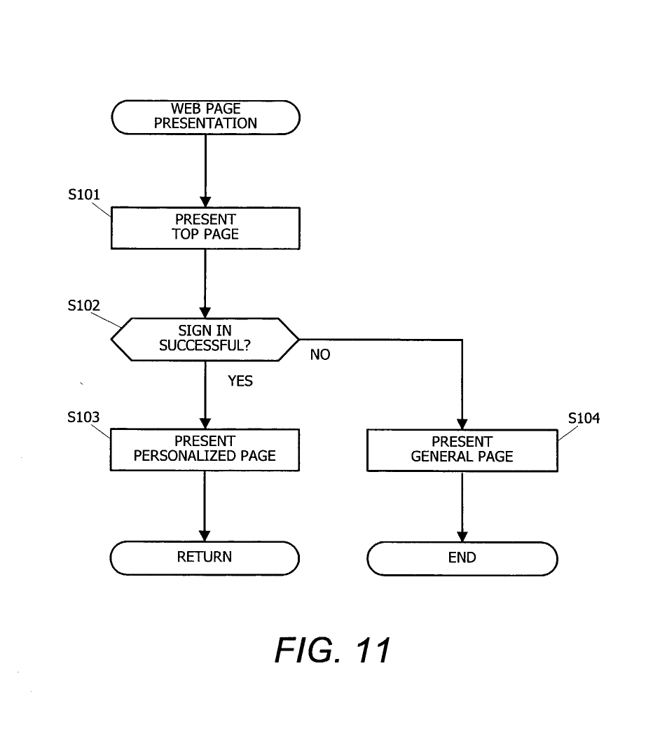

Detailed steps of the web page presentation process (step S1) will now be described with reference to FIG. 11. At beginning of the web page presentation process, the shopping server 15 retrieves data representing a top page (written in HTML, for example) for sign-in from the DB 253 (web page data), and transmits it to the client terminal 31 concerned (step S101).

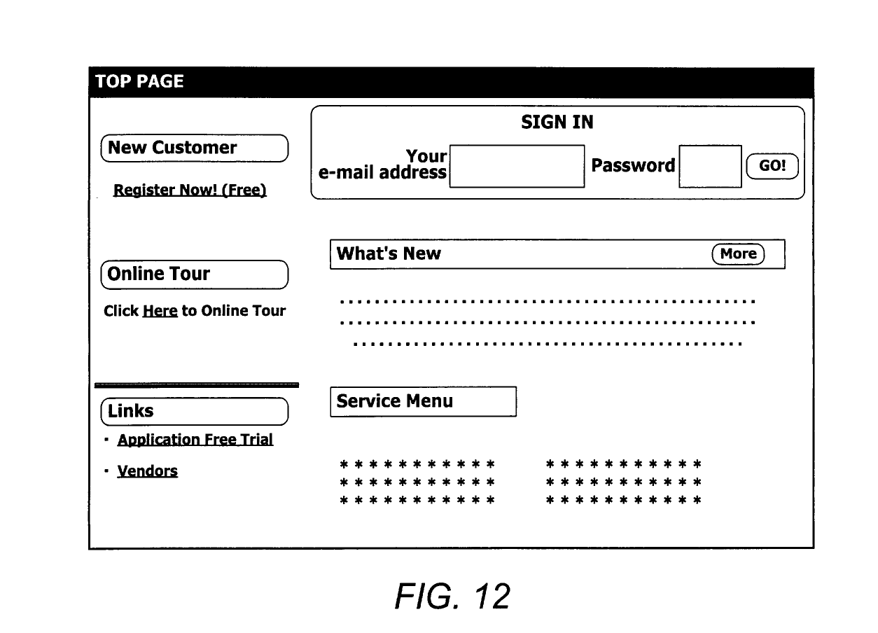

As shown in FIG. 12, the top page has text boxes to input login account (e-mail address and password). The user concerned inputs his/her account and clicks “Go” button, thus, the input information is transmitted to the shopping server 15.

The shopping server 15 receives the user account information, and refers to the “online user data” in the DB 251 to discriminate whether the login user is allowed to sign-in for a personalized page (step S102). If the given user account has not been registered or other access request is received (step S102: No), the shopping server 15 provides the client terminal 31 of a general page (step S104).

On the contrary, the sign-in is succeeded (step S102: Yes), the shopping server 15 provides the client terminal 31 of the personalized page (step S103).

Once the user is specified, the shopping server 15 retrieves information of sales agent dealing with the user concerned, customer grade, owning items, recommended items, and message from the DB 251 (online user data). Then, the shopping server 15 retrieves data representing portrait image of the sales agent and pictures of the recommended items from the DB 252 (material data). The shopping server 15 determines supply items being compatible with the items being owned by the user based on the data representing owning items and item relation data stored in the DB 257. The shopping server 15 retrieves data representing images of the supply items from the DB 252 (material data).

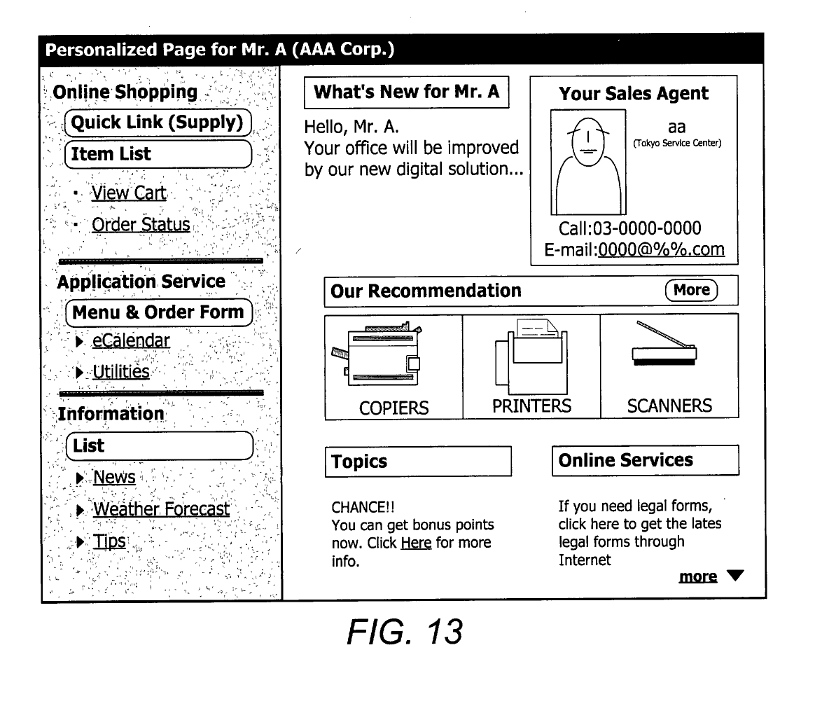

The shopping server 15 arranges those data to generate a personalized web page as shown in FIG. 13, and transmits it to the client terminal 31 concerned. Thus the personalized page is presented, and the web page presentation process is terminated.

As shown in FIG. 13, the personalized page may be visually divided by frames. In FIG. 13, a leftward frame mainly shows objects as navigators to other web pages in the site. A rightward frame is a main page of the personalized page, and includes a message from the sales agent (top-left), information about the sales agent (top-right), information representing recommended items (middle), other information (bottom), and the like.

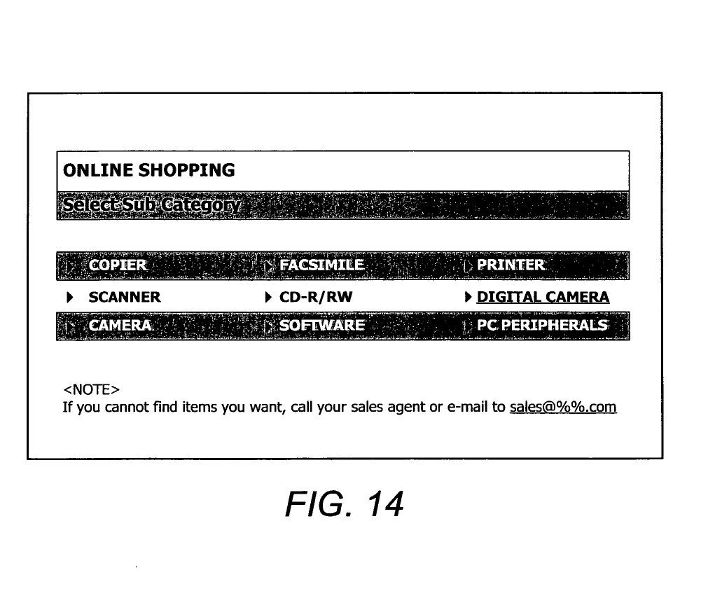

Some of the navigators on the left frame link to pages for using the online shopping service. A process after the navigator object “Item List” has been clicked will now be described. An Item List page shows items being handled by the online shopping service as shown in FIG. 14. As shown in FIG. 14, the items are categorized on the page.

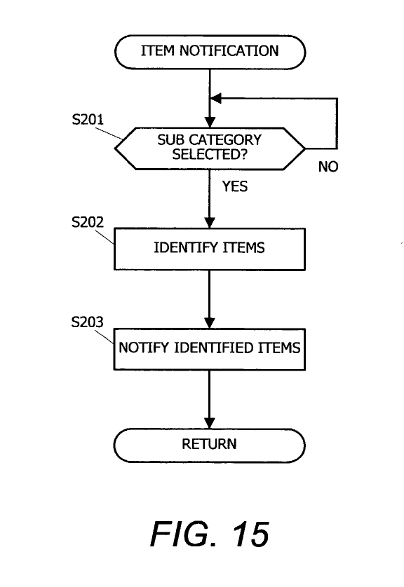

Detailed steps of “Item Notification Process” (step S2: FIG. 10) which follows to the web page presentation process will now be described with reference to FIG. 15.

The item notification process starts after the shopping server 15 presents the item list page to the client terminal 31 concerned. The shopping server 15 waits for the user's instruction representing a sub category including items corresponding to the user's demand (step S201).

Once the sub category is selected (step S201: Yes), the shopping server 15 accesses the DB 254 (item data) to retrieve item codes of the items included in the selected sub category (step S202). Thus, the shopping server 15 identifies the items belonging to the sub category selected by the user.

After the item identification, the shopping server 15 transmits the items codes to the shipping arrange server 17, thus, the items are notified to the shipping arrange server 17 (step S203), and the item notification process is terminated.

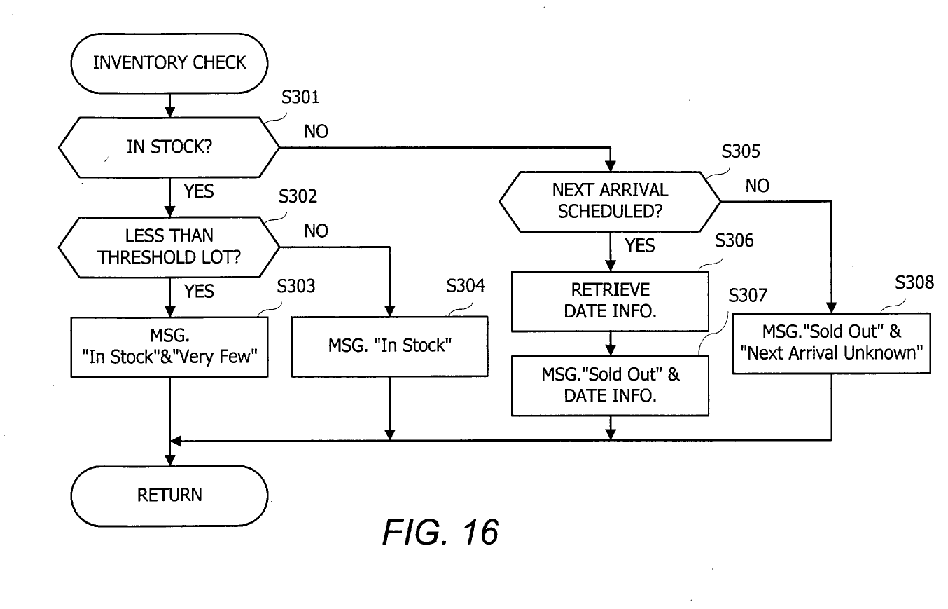

Then, “Inventory Check Process” (step S3: FIG. 10) follows to the item notification process. Detailed steps in the inventory check process will now be described with reference to FIG. 16. The shipping arrange server 17 carries out the inventory check process in response to the completion of the item notification.

The shipping arrange server 17 accesses the DB 274 (inventory data) to determine whether the notified items are stocked or not (step S301). More precisely, the shipping arrange server 17 identifies the notified items, and checks the “Stock Status” column for the identified items one after another.

If the item concerned is “in-stock” (step S301: Yes), the shipping arrange server 17 further refers to “Lot” column to determine whether the stocked lot is less than predetermined threshold or not (step S302). If the stocked lot is less than the threshold (step S302: Yes), the shipping arrange server 17 transmits messages “In-stock” and “Very Few” to the shopping server 15 together with the item code representing the item concerned (step S303). On the other hand, if the stocked lot exceeds the threshold (step S302: No), the shipping arrange server 17 transmits a message “In-stock” to the shopping server 15 (step S304).

If the item concerned is not stocked (step S301: No), the shipping arrange server 17 refers to the “Next Arrival” column for the item concerned to determine whether the next arrival is scheduled or not (step S305). If the next arrival is scheduled (step S305: Yes), the shipping arrange server 17 retrieves date information representing the date of next arrival (step S306), and transmits a message “Sold Out” and the date information to the shopping server 15 together with the item code representing the item concerned (step S307).

On the contrary, if the next arrival of the sold out item is not scheduled (step S305: No), the shipping arrange server 17 transmits messages “Sold Out” and “Next Arrival Unknown” with the item code to the shopping server 15. After the shipping arrange server 17 completes the above processing for each items notified, the shipping arrange server 17 terminates the inventory check process.

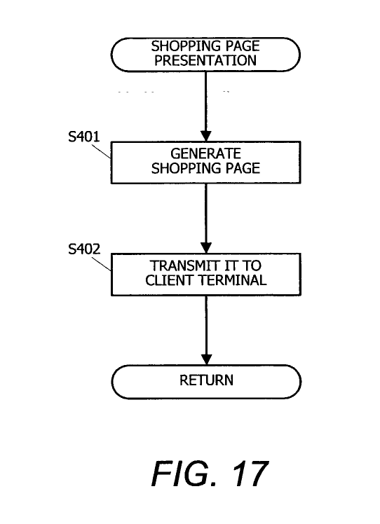

Then, “Shopping Page Presentation” process (step S4: FIG. 10) follows to the inventory check process. Detailed steps of the shopping page presentation process will now be described with reference to FIG. 17. The shopping server 15 carries out the shopping page presentation process in response to the completion of the notification of the stock status.

The shopping server 15 retrieves image or text data regarding to the items selected through the item notification process (step S2) from the DB 252 (material data) and the like, to generate a shopping page (step S401). At this step, the shopping server 15 flexibly and automatically edits or arranges the page based on the information provided by the shipping arrange server 17. More precisely, the shopping server 15 applies the information of the stock status to the page, and affixes an object “Sales Agent” (which directly links to the sales agent dealing with the user concerned) to the information of the item which is being sold out. Thus, the shopping page is edited dynamically in accordance with the stock status.

In addition, the shopping server 15 calculates discount rate based on the customer grade retrieved from the DB 251 (online user data) at step S104, and applies the discounted price as “Sales Price” to the shopping page. For example, the shopping server 15 may calculates a formula “(Standard Price×(1-discount rate))” to obtain sales price.

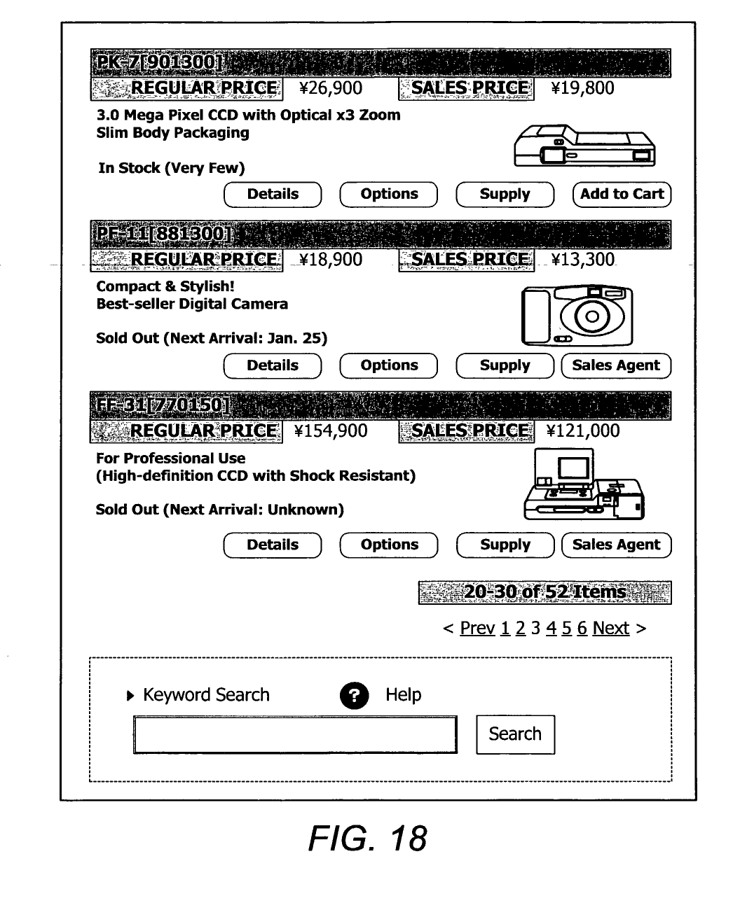

The shopping server 15 transmits data representing thus generated shopping page as shown in FIG. 18 to the client terminal 31 concerned (step S402), thus the shopping page is presented to the user at through the client terminal 31. The user may proceed the online shopping through the shopping page.

As shown in FIG. 18, the shopping page presents stock status information such as “In Stock (Very Few)”, “Sold Out (Next Arrival: Jan. 25)”, “Sold Out (Next Arrival: Unknown), and the like item by item, however, those information may be edited flexibly. For example, such the stock status information may be omitted for the items which are “In Stock”. As illustrated, a button “Sales Agent” is applied to the item which is “Sold Out”. The button may link to e-mail transmission to the sales agent. If a desired item is sold out, the user may click the “Sales Agent” button to contact to the sales agent for reservation and the like.

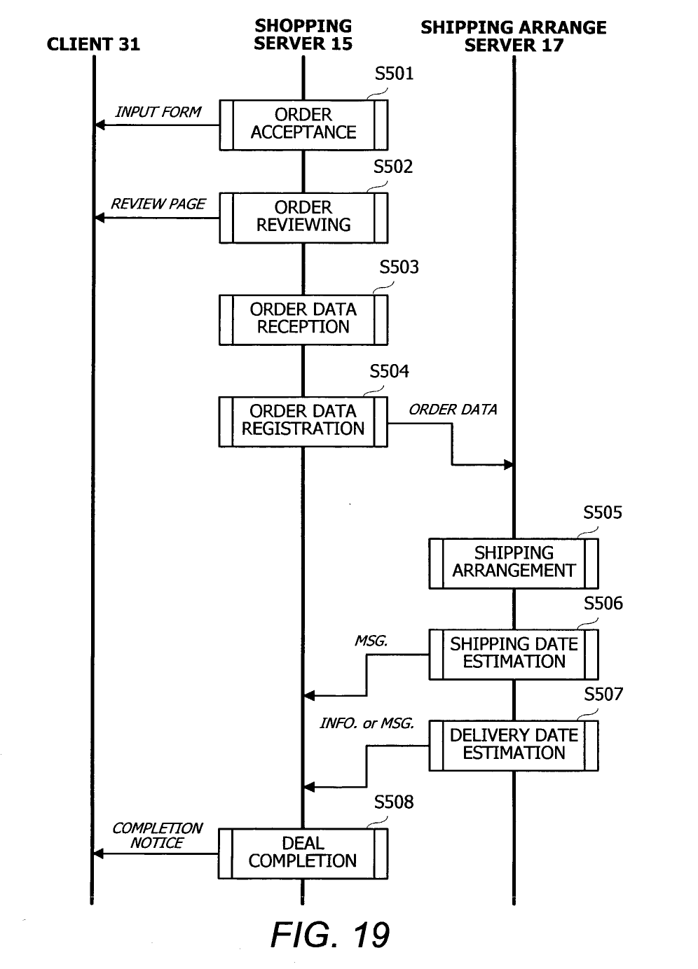

Then the shopping server 15 carries out “Order Acceptance Process” (step S501) shown in FIG. 19 describes process flow after preparation for ordering has been completed. The shopping server 15 starts the order acceptance process in response to item designation by the client terminal 31, to accept an order from the client terminal 31 concerned.

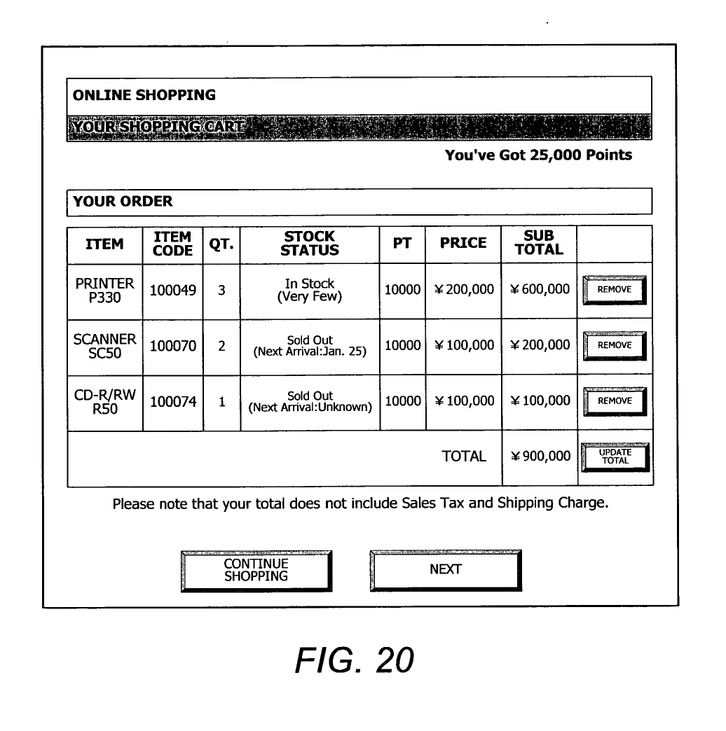

A shown in FIG. 18, the available item (in-stock item) has an accompanying object “Add to Cart”. If a user desires to order that item, the “Add to Cart” button will be clicked. In response to that action, the shopping server 15 returns a page for viewing the cart as shown in FIG. 20 to the client terminal 31. If the user decide to order the items in the cart, “Next” button will be clicked to proceed to the next stage of the ordering. In other words, information representing the items in the cart will be transmitted to the shopping server 15 which has been ready for accepting the order.

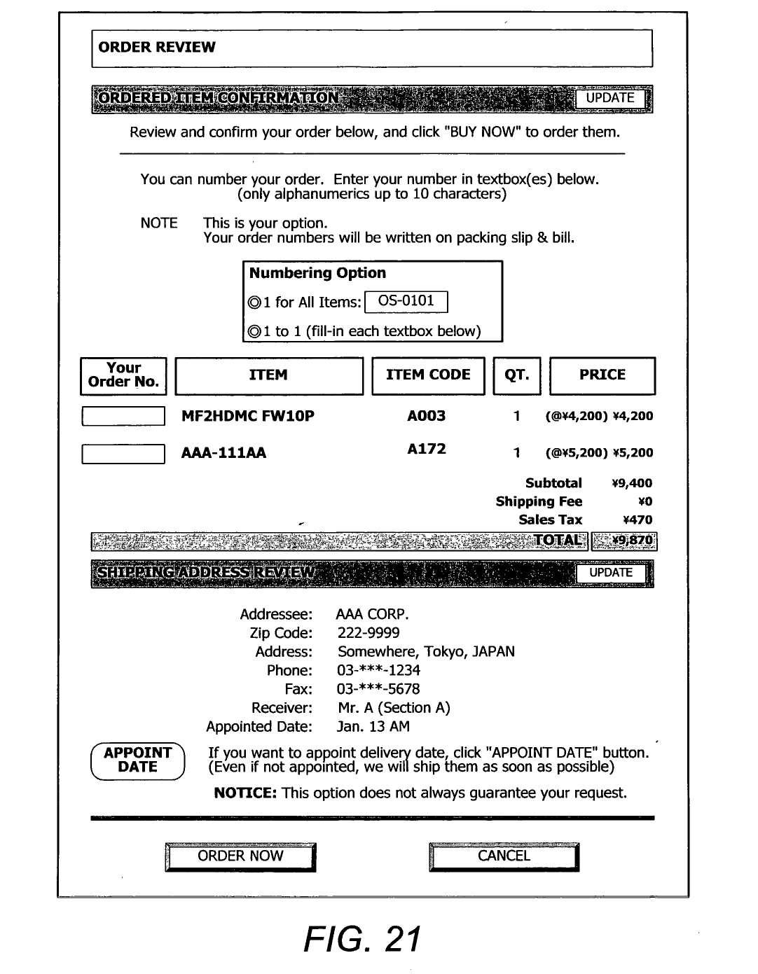

In response to the acceptance of the order, the shopping server 15 carries out “Order Reviewing Process” (step S502). At this step, the shopping server 15 transmits a page as shown in FIG. 21 to the client terminal 31 for allowing the user to review or confirm the order, shipping address, and the like.

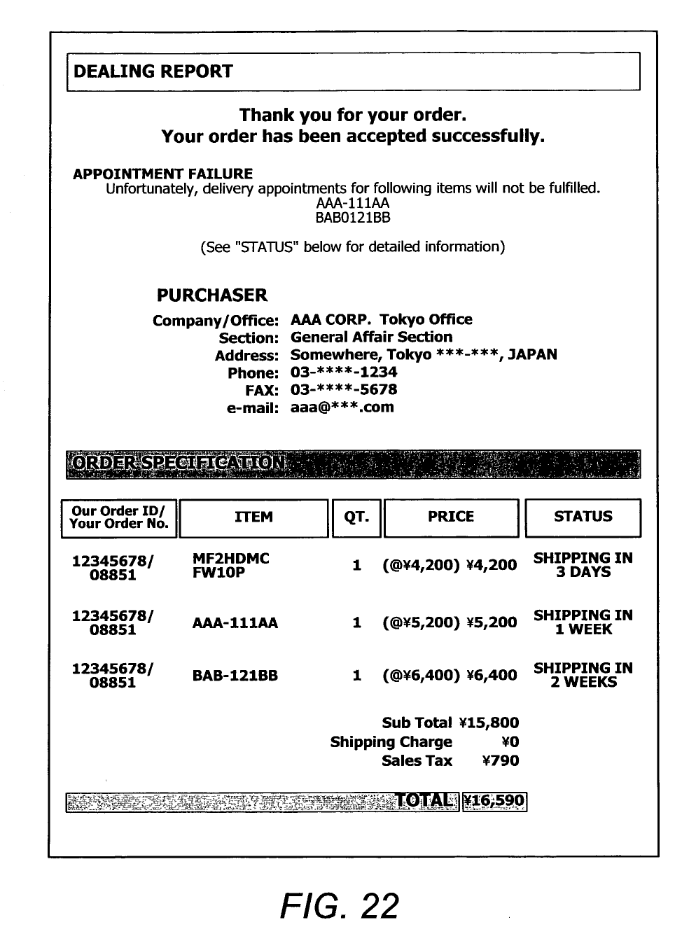

If the user concerned has been determined as the business user through the web page presentation process (step S1), the order review page, as shown in FIG. 22, has text boxes for allowing the user to apply the user's own order No. (hereinafter, referred to as “user's No.”) to the order concerned. The user has a further option whether applying single number for all items or separate numbers for each item. For this option, the text boxes for the order numbers are prepared separately. If the user desires to apply their own order No. to the order, the user may input desired number(s) to the text box(es) and click “Order Now” button at the bottom of the page.

In response to the depression of “Order Now” button, information representing the items ordered (hereinafter, referred to as “order data”) is transmitted to the shopping server 15. If the order number has been applied, information representing the order number is also transmitted to the shopping server 15 together with the order data.

In response to order data reception (step S503), the shopping server 15 issues another order No. which will be handled by the merchandiser. To distinguish from the “user's No.”, such the order No. issued by the merchandiser will be referred to as “order ID” in this embodiment. The shopping server 15 accesses the DB 256 (order data) to register the data of the order concerned with associating “user's No.” and “order ID” with each other (step S504).

Then, the shopping server 15 transmits the order data to the shipping arrange server 17. In response to the notification of the order data, the shipping arrange server 17 sequentially carries out processes for “Shipping Arrangement” (step S505), “Shipping Date Decision” (step S506), and “Delivery Date Decision” (step S507).

In the shipping arrangement process, the shipping arrange server 17 refers to the data stored in the shipment DB system 27 to specify an appropriate delivery center which can delivery the ordered items to the user concerned. The shipping arrange server 17 instructs the specified delivery center to proceed the delivery in accordance with the order. If necessary, the shipping arrange server 17 contacts to some delivery centers to instruct them to arrange the inventories in order to make up for shortages.

Through the shipping date estimation process, the shipping arrange server 17 refers to information of scheduled date of next arrival or delivery lead-time for each ordered item, to estimate a date for shipping.

And the shipping arrange server 17 estimate a date of delivery through the delivery date estimation process, based on the date appointed by the user and the like, and notifies the estimated date to the shopping server 15.

In response to the notification of the delivery date, the shopping server 15 carries out “Deal Completion Process” (step S508). Through the deal completion process, the shopping server 15 generates a dealing report page as shown in FIG. 22 which indicates the delivery dates item by item, and transmits it to the client terminal 31 concerned. Thus, the user is notified that the order has been accepted successfully.

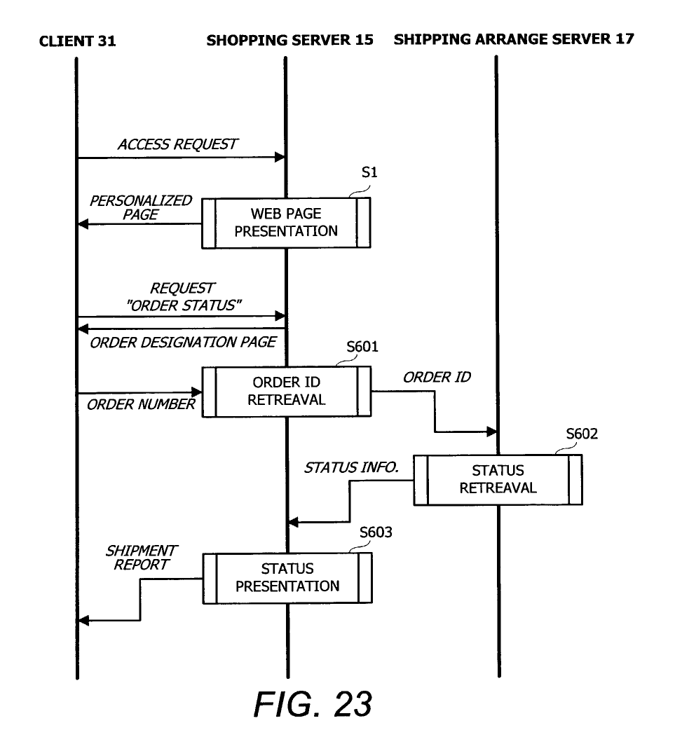

Process flow for viewing order status by the user will now be described with reference to a flowchart shown in FIG. 23.

In response to the access from the client terminal 31, the shopping server 15 executes the web page presentation process (step S1: FIG. 10), thus, the personalized page (FIG. 13) is provided to the client terminal 31.

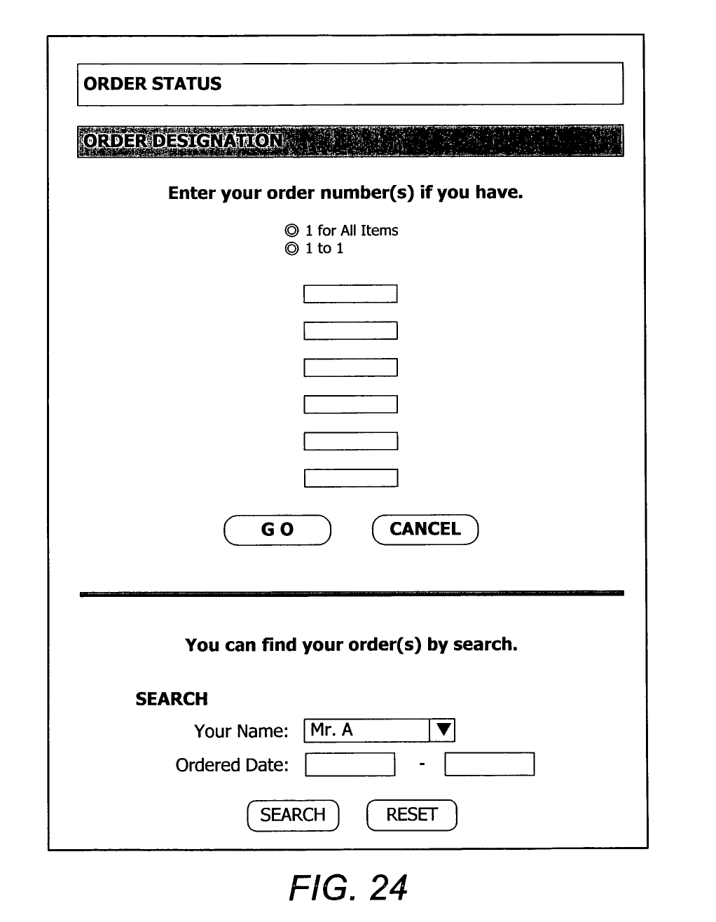

In a case where a business user clicks a navigator object “Order Status” on the left frame of the personalized page, the shopping server 15 generates “Order Status” page as shown in 24, and transmit it to the client terminal 31. As shown in FIG. 24, the order status page has text boxes for allowing the user to input user's Nos. The user may input user's Nos. and click “Transmit” button for designating the target order. That is, in response to the depression of the “Transmit” button, the client terminal 31 transmits information representing the input user's numbers to the shopping server 15.

In response to the reception of the user's numbers, the shopping server 15 accesses the DB 256 (order data) to search for “order ID” being associated with the user's numbers concerned. The shopping server 15 notifies the found order ID to the shipping arrange server 17 (step S601).

The shipping arrange server 17 accesses the shipment DB system 27 to retrieve information representing the status of the order which is identified by the notified order ID (step S602). The shipping arrange server 17 notifies the status to the shopping server 15.

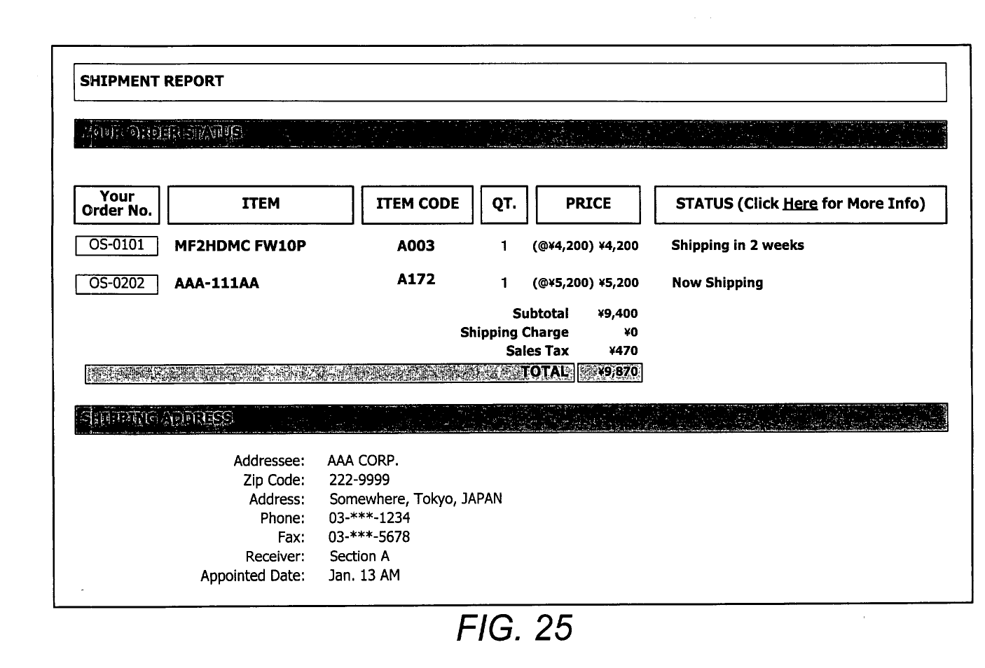

The shopping server 15 generates a shipment report page as shown in FIG. 25 based on the notified status of the order, and transmits it to the client terminal 31 concerned (step S603). As shown in FIG. 25, the shipment report page indicates the user's numbers and information representing the status of shipments for each item.

As described above, the system according to this embodiment allows the registered users to handle their own order numbers when using the online shopping service. In addition, such the user's own numbers are applicable to obtain order status and the like. In other words, the users are allowed to handle only their own numbers, thus, their management tasks for purchasing will be simplified.

Various embodiments and changes may be made thereunto without departing from the broad spirit and scope of the invention. Though the above embodiment exemplifies the collaboration of the system for merchandising the goods at the shops with another for the online shopping, the target merchandises are not limited to the goods. For example, the online shopping system may collaborate with a system handling digital contents (images, music, and the like), service, or the like.

Arbitrary modifications onto the configurations of the servers or databases may be also allowed. Though the above embodiment exemplifies that each shop has a single in-shop terminal 11 as shown in FIGS. 1 and 2 for comprehensive description, a plurality of the in-shop terminals 11 may be installed in a shop. Those terminals may collaborate with each other via LAN. Each of the master server 13 and the shopping server 15 may include several server machines those collaborate with each other. The configurations of the databases also accepts arbitrary modifications. For example, integration of some databases works as a database for single purpose, or a single database may be functionally divided into some databases for different purposes. Though the servers or the databases share the same data in the above embodiment, such the data may be omitted or simplified. For example, instead of registering information representing relations between a completed item and option items or supply items to the DB 233 (item relations), such the relationship may be determined based on the item data stored in the DB 231 of the master DB system 23.

Or, the DB 233 (item relations) may be omitted. In this case, process regarding to the items relations may be handled with using the item data in the DB 257. In the same manner, the link information in the master DB system 23 may be omitted, while registering such the information only to the shopping DB system 25.

As described above, the present invention realizes the network system which allows the users to handle their own discriminative information applicable to the electronic commerce. More particularly, this effect is helpful for the business users to simplify their tasks for managing discriminative information even if they use the online shopping service.

The above-described embodiment is intended to illustrate the present invention, not to limit the scope of the present invention. The scope of the present invention is shown by the attached claims rather than the embodiment. Various modifications made within the meaning of an equivalent of the claims of the invention and within the claims are to be regarded to be in the scope of the present invention.

This application is based on Japanese Patent Application 2001-356665 filed on Nov. 21, 2001 and including specification, claims, drawings and summary. The disclosure of the above Japanese Patent Application is incorporated herein by reference in its entirety.

What is claimed is:

1. A network system which provides a site for merchandising based on interactions with a terminal device connected to a network, comprising:
an information acceptor for accepting an order from said terminal device with first discriminative information designated by said terminal for discriminate said order;
an information generator for generating second discriminative information for discriminating said order;
an information storage for storing said first discriminative information accepted by said information acceptor and said first discriminative information generated by said information generator with associating said first discriminative information and second discriminative information with each other;
an order storage for storing order information representing details of said order and said second discriminative information generated by said information generator with associating said order information and second discriminative information with each other;
an information receiver for receiving said first discriminative information from said terminal device;
an information searcher for searching said information storage to find second discriminative information being associated with said first discriminative information received by said information receiver in response to the reception by said information receiver; and
an information presenter for presenting order information obtained from said order storage based on said second discriminative information found by said information searcher to said terminal device.

2. The network system according to claim 1, further comprising:
a discriminative information storage for storing discriminative information including user information for identifying users and organization information for identifying organizations to which the users belong, while associating the user information and the organization information with each other; and
an attribution discriminator for discriminating attribution of a user who accesses said site by determining whether organization information associated with user information of the user concerned is stored in said discriminative information storage or not, wherein
said information acceptor accepts said first discriminative information in a case where said user attribution discriminator determines that the organization information associated with the user is stored.

3. The network system according to claim 1, wherein
said first discriminative information includes item information which represents ordered items included in the order discriminated by said first discriminative information.

4. The network system according to claim 1, wherein
said order information includes at least item information representing ordered items, quantity information representing ordered quantities, price information representing prices of the ordered items, date information representing order date, destination information representing destination of the ordered items, and status information representing shipment status of the ordered items.

5. A method for providing online shopping service comprising:
accepting an order from a terminal device via a network with arbitrary first discriminative information designated by said terminal device for discriminating said order;
generating second discriminative information for discriminating said order;
storing said first discriminative information, said second discriminative information, and order information representing details of said order, while associating said first discriminative information, second discriminative information, and said order information with each other;
updating said order information in accordance with process for accepting said order; and
specifying second discriminative information being associated with first discriminative information given by said terminal device, and presenting updated order information being associated with said specified second discriminative information to said terminal device.

6. A method for managing discriminative information which is applicable to a network system for providing merchandising service with handling interactions with a terminal device connected to a network, comprising the steps of:
accepting an order from said terminal device with first discriminative information designated by said terminal device for discriminating said order;
generating second discriminative information for discriminating said order so as to be associated with said order;
storing said accepted first discriminative information and said generated second discriminative information while associating said first discriminative information and said second discriminative information with each other;
storing order information representing details of said order and said second discriminative information associated with said order while associating said order information and said second discriminative information with each other;
receiving said first discriminative information from said terminal device;
specifying associated second discriminative information based on said received first discriminative information; and
obtaining associated order information based on said specified second discriminative information, and presenting said order information to said terminal device.

7. A server connected to a network for providing a site for merchandising with dealing with a terminal device connected to said network, comprising:
a connecting unit which connects said server to said network;
an order accepting unit which controls said connector to accept an order from said terminal device together with first discriminative information arbitrary designated by said terminal device for discriminating said order;
an information generating unit which generates second discriminative information for discriminating said order accepted by said order accepting unit;
an information storing unit which stores said first discriminative information accepted by said order accepting unit and said second discriminative information generated by said information generating unit so that said first discriminative information is associated with said second discriminative information;
an order information storing unit which stores order information representing details of said order accepted by said order accepting unit and said second discriminative information generated by said information generating unit so that said order information is associated with said second discriminative information;
an information receiving unit which controls said connecting unit to receive first discriminative information from said terminal device;
an discriminative information retrieving unit which retrieves associated second discriminative information from said information storing unit in accordance with said first discriminative information received by said information receiving unit;
an order information retrieving unit which retrieves associating order information from said order information storing unit based on said second discriminative information retrieved by said discriminative information retrieving unit; and
a order information transmitting unit which controls said connecting unit to transmit said order information retrieved by said order information retrieving unit to said terminal device.

8. The server according to claim 7, further comprising an input page transmitting unit which controls to said connector to transmit an input page for inputting information representing said first discriminative information, to said terminal device.

9. The server according to claim 8, further comprising:
a discriminative information storing unit which stores discriminative information including user information for identifying users and organization information for identifying organizations to which the users belong so that the organization information is associated with the user information; and
an attribution discriminating unit which determines whether the user information of a user who accesses said server has associated organization information or not, to discriminate attribution of the user concerned, wherein
said information input page presenting unit presents said input page in a case where said attribution discriminating unit determines that the user information has the associated organization information.

10. A recording medium storing a program which makes a computer work as said server according to claim 7.
